(19) United States
(12) Patent Application Publication
(10) Pub. No.: US 2004/0074145 A1
(43) Pub. Date: Apr. 22, 2004

(54) Sliding rail door-closing device

(76) Inventor: Jurgen Homberg, Hagen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/467,986

(22) PCT Filed: Feb. 11, 2002
(86) PCT No.: PCT/EP02/01404

(30) Foreign Application Priority Data
Feb. 13, 2001 (DE) 101 07 046.2

(51) Int. Cl. E06B 7/08

(52) U.S. Cl. 49/64; 49/49

(57) ABSTRACT

This invention relates to an overhead door closer with slide arm assembly (1) having a toothed pinion (6) that is eccentrically supported and presents a circular rolling curve, which pinion meshes with a toothed rack (5) arranged at a piston (4). The invention concentrates on a particular embodiment of the rolling curve and of the teeth (9) of the toothed rack (5) in adaptation to a toothing of the pinion (6). Furthermore, the invention concentrates on an improved embodiment of the delayed closing operation in order to achieve an optimized movement pattern of the piston (4) within the housing (2) of the overhead door closer with slide arm assembly (1).

This invention relates to an overhead door closer with slide arm assembly, having a piston being guided in a housing and leaning against a closing spring, having a toothed pinion being eccentrically, rotatably supported at the housing, and meshing with a toothed rack of the piston, which pinion presents a circular rolling curve, the central point thereof being offset, in relation to the rotary axis of the pinion in the closing position, into the direction towards the toothed rack, and in relation to the rotary axis in the opening position, into the opposite direction.

The above described overhead door closers with slide arm assembly, also known as rack and pinion door closers, with regard to traditional door closers, advantageously do not present an arm assembly protruding uncovered into the room, but they simply present an actuation arm sitting close and flat at the door frame or at the door leaf. They do, however, bear the disadvantage that the actuation arm, sitting close and flat at the door frame or at the door leaf, leads to an unfavourable course of forces at the door, in relation with conventional, symmetric rack and pinion mechanics. It is therefore an object to conceive an optimal rack and pinion drive, with the intention to achieve, during the opening procedure and closing procedure of the door, an operation of the pinion, as low in friction and smooth as possible, at the associated toothed rack and therefore of the piston inside the piston housing.

Centrically or eccentrically supported pinions are used in known door closers.

A door closer species, described at the beginning, having an eccentrically supported pinion is known from EP 0 856 628 A1, wherein the toothing of the toothed rack forms a linearly extending pitch line of engagement having an angle comprised between 4.5° and 7.2° with regard to the moving direction of the piston. The selection of an angle depends on the size of the door closer, respectively on the strength of the closing spring. Because of the eccentric support of the pinion and of the linear course of the toothed rack, an optimal, especially low friction and smooth progress of the pinion's teeth at the toothed rack is not guaranteed; there are spreads in the course of the momentums' curves.

A comparable solution applying a linearly extending toothed rack with an angle is described in U.S. Pat. No. 633,682.

Furthermore DE 36 45 313 C2 and DE 36 45 314 C2 reveal an eccentrically supported pinion where a rolling curve, arranged at the pinion, is used, having various lever arms in relation to the rotary axis. Accordingly, the rolling curve of the associated toothed rack extends in an arcuate form.

In a door closer known from DE 82 17 72 C2 respectively from the French Patent Application 96 69 45, the closer shaft is connected at an eccentrically supported elliptical toothed wheel meshing with an inclined toothed rack on the piston side. Up to a certain degree, a transmission, adapted to a desired course of the momentum, is achieved by means of the elliptical gear due to the differently long lever arms of the elliptical toothed wheel.

The pneumatic door closer according to U.S. Pat. No. 1,359,144 presents a circular eccentrically supported pinion which meshes with an uneven toothed rack at the piston. The circular pinion is provided with a regular toothing on a circular rolling curve, whereby varying lever arms come into effect due to the eccentrical support.

Various piston drive embodiments in door closers are described in DE 36 38 353 A1, in EP 0 207 251 A2, in DE 94 12 64 and in U.S. Pat. No. 2,933,755, whereby in relation with eccentrically or centrically supported pinions—if necessary with insertion of a transmitting gear drive—a direct charge of the closing spring is exerted by means of a crank drive.

Centrically supported pinions are known from EP 0 056 256 A2 as well as from EP 0 350 568 A2. EP 0 056 256 A2 deals with a door closer, the pistons thereof presenting two symmetrically, diametrically opposite toothed racks, whereby a centrically supported pinion engages, in the closing position, with shortened teeth, in both toothed racks of the piston.

The door closer according to EP 0 350 568 A2 presents a centrically supported pinion, which presents teeth extending at the circumference, with progressively increasing depths of teeth, which teeth engage between the rods of a correspondingly curve-shaped extending toothed rack.

A substantially centrically supported pinion of a drive for a door or for a window is disclosed in DE 44 44 131 A1 and DE 44 44 133 B1, wherein the pinion itself presents a toothing over up to approximately half the circumference thereof, the teeth thereof being disposed at lever arms varying in length and progressing on a correspondingly curved rolling curve of a toothed rack.

The object of the invention is to optimize, within the door closer housing, the progression of movements of the piston of the overhead door closer with slide arm assembly during the opening procedure and the closing procedure, i.e. to guarantee especially a jam-free and therefore low friction progression of the pinion at the toothed rack of the piston. By using a pinion having an appropriate rolling curve, the pinion's cost of production should be minimized, whereby, compared to known toothed racks, a particular embodiment of the toothed rack, due to the intended low friction to be achieved, should result in a longer lasting working life and in higher efficiency, which in return allows for using a weaker closing spring. In execution of the invention an improvement of the closing characteristics of the overhead door closer with slide arm assembly should be achieved additionally through an improved oil exchange from the piston chamber to the spring chamber during the closing procedure.

The invention solves the given problem with the teaching according to the claims 1, 3, and 4.

According to the invention, a toothed rack, respectively the teeth thereof are adapted in an optimal way to the progression of a toothing of a pinion, while taking into account its eccentrical support and its circular rolling curve, such that a smooth transition to each following adjacent tooth is guaranteed, during the opening procedure as well as during the closing procedure. This applies particularly to the portion of the pinion exceeding the rotation of 180°. In this case, it has proven to be advantageous that the opening-sided teeth's flank angle of the toothed rack be executed substantially in ascending manner up to approximately half the length of the toothed rack, and subsequently they be executed substantially in a constant or descending manner, whereby the descending course contributes to improving the low friction.

The rotation of the pinion, from the closing position up to the maximum opening position, may comprise more or less than approximately 180°, without having any negative influence on the required effectiveness. It is essential that the closing-sided tooth profiles of the last teeth of the toothed rack in the opening direction, arranged in the portion adjoining the 180°, be executed with an angle or rounded.

Further characteristics of the invention are characterized by the sub-claims.

In execution of the invention basically optional tooth forms may be used; i.e. the pinion and/or the toothed rack may present teeth with straight, angled or convex curved tooth profiles. However, it has proven to be advantageous—especially for reasons regarding production techniques—to attribute substantially a spur toothing to the toothed rack and an involute toothing to the pinion.

The invention includes furthermore an improvement of the closing characteristics through the improved oil exchange.

Accordingly, the closing procedure comprises four closing phases, each closing phase, while including a certain tolerance, being associated in an already known manner to one closing angle. The first closing phase, as well as the third one, may be controlled through a single valve by means of the longitudinal groove that is arranged in the skirt of the piston such that the low friction course of the pinion at the toothed rack, attainable with the characteristics a) to d), is assisted by an advantageous embodiment of the oil exchange between the piston chamber and the spring chamber during the closing procedure, whereby it is not necessary to use a commonly required valve for the third closing phase.

The invention will be explained in detail on the basis of a diagrammatically represented possible embodiment example, in which

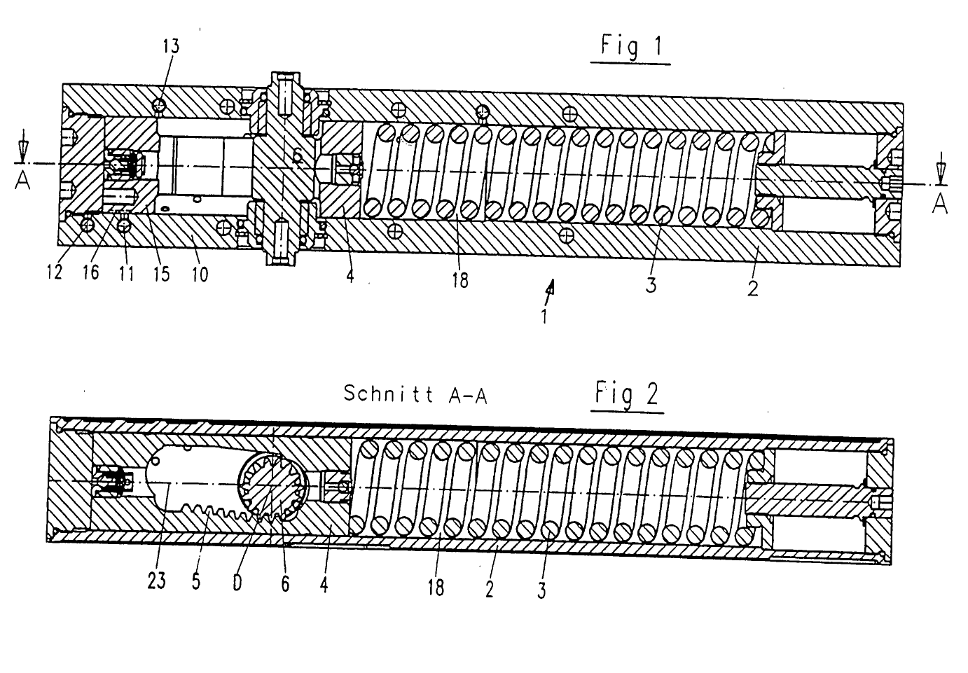

FIG. 1 shows a vertical section through a door closer housing.

FIG. 2 shows a section following line A—A according to FIG. 1.

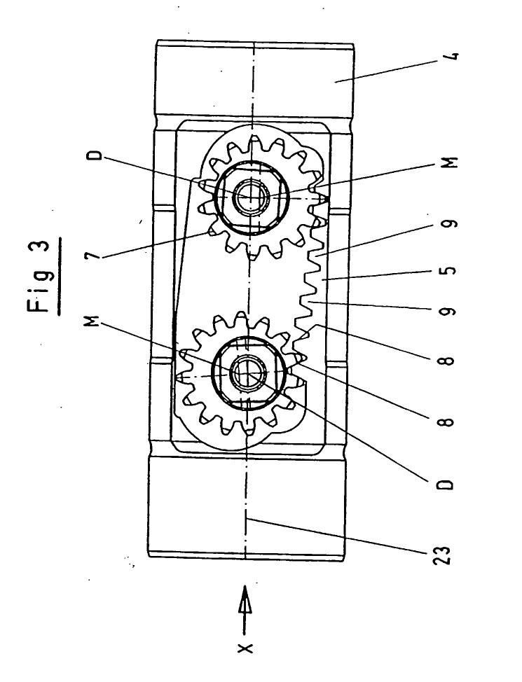

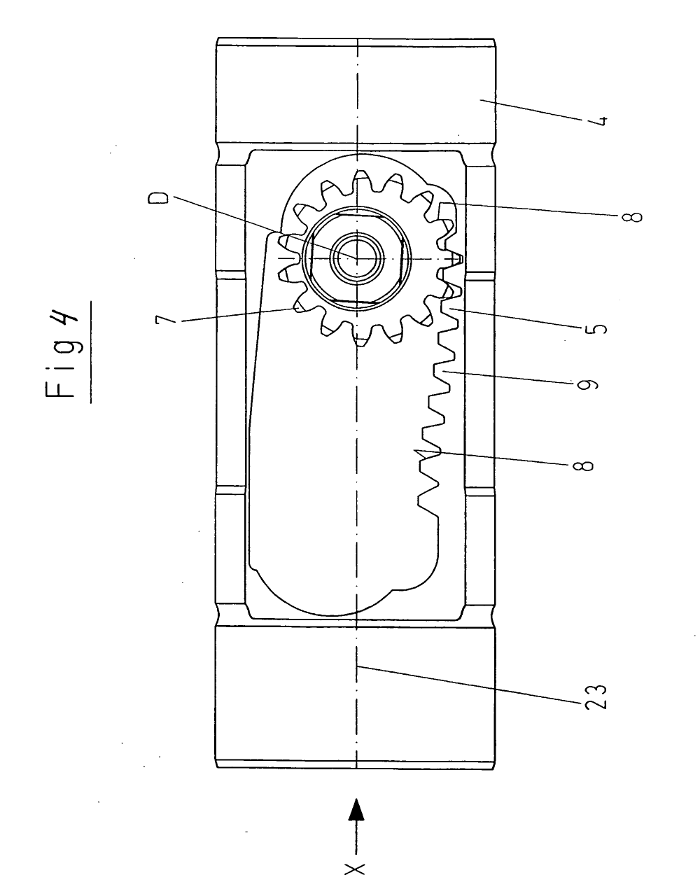

FIG. 3 shows a plane view on the piston including two end positions of the pinion.

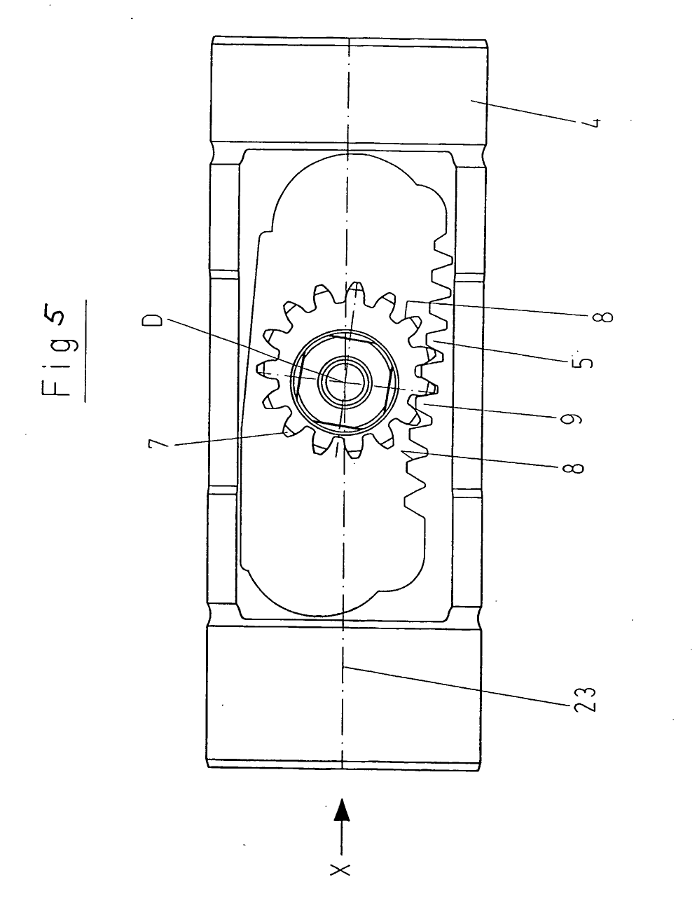

FIGS. 4 to 6 show three phases of the pinion's course at a toothed rack.

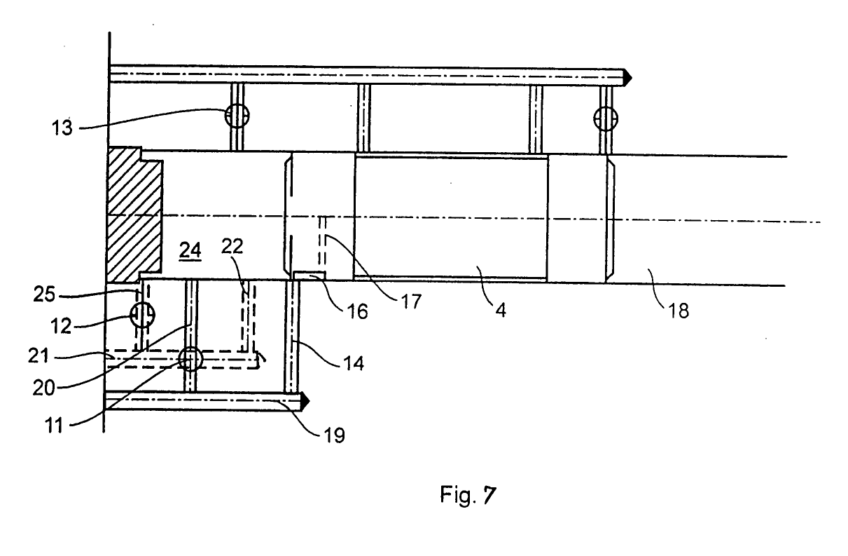

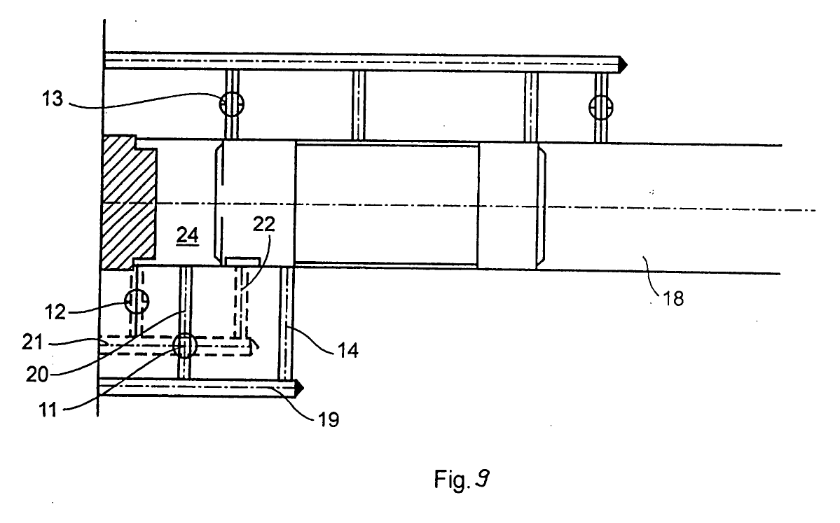

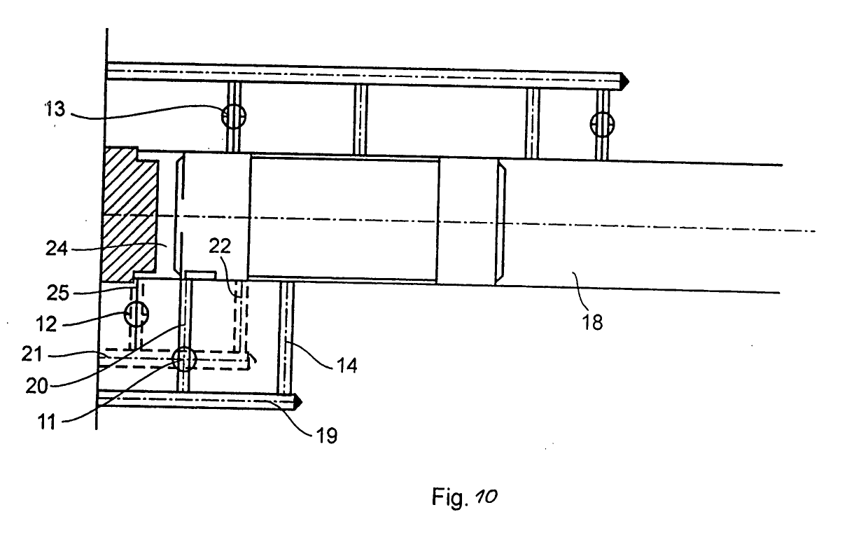

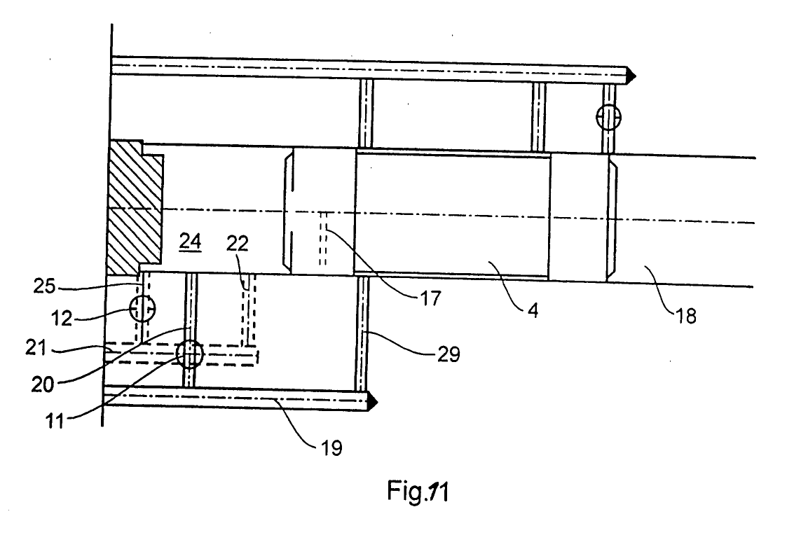

FIGS. 7 to 10 show in a diagrammatical illustration, four positions of the piston during the delayed closing operation.

FIG. 11 shows a second embodiment of the delayed closing operation.

According to FIGS. 1 to 6, a closing spring 3 acts on a piston 4 which is guided in a housing 2 of an overhead door closer with slide arm assembly 1. As illustrated in FIGS. 2 and 3, the piston 4 has a toothed rack 5 meshing with a pinion 6, which presents an involute toothing 7. In the region of the center longitudinal axis referenced to with numeral 23, the pinion 6 is eccentrically supported in the rotary axis referenced to with D, whereby in the closing position of pinion 6, illustrated in FIG. 3, a central point M of the rolling circle of pinion 6 is offset into the direction towards the toothed rack 5, and in the opening position, illustrated in FIG. 3, the central point M of the rolling circle of pinion 6 is offset into the opposite direction. The rolling curve of pinion 6, as can be seen, is circular. The teeth of toothed rack 5, generally referenced to with numeral 9, present opening-sided tooth profiles and closing-sided tooth profiles, whereby the closing-sided tooth profiles 8 (see FIG. 3) of the last two teeth 9 are executed with an angle. The tooth profiles of all the other teeth 9 present a straight course. The afore-mentioned measure guarantees that during a movement of piston 4 in the direction of arrow X (opening direction) when the pinion 6 progresses on the toothed rack 5, even in the region, in which the pinion 6 has slightly exceeded the rotation about 180° (see closing position of the pinion 6 in FIG. 3), a low friction mating of the involute toothing 7 with the teeth 9 of toothed rack 5 is realised. By the way, the rolling curve of the toothed rack 5 is adapted to the eccentrical support of pinion 6 and presents a correspondingly slightly S-shaped course, whereby all teeth 9 of the toothed rack 5 present different flank angles on the opening-side and on the closing-side, as can be seen in FIGS. 4 to 6, illustrating the pinion's progression at the toothed rack in three phases.

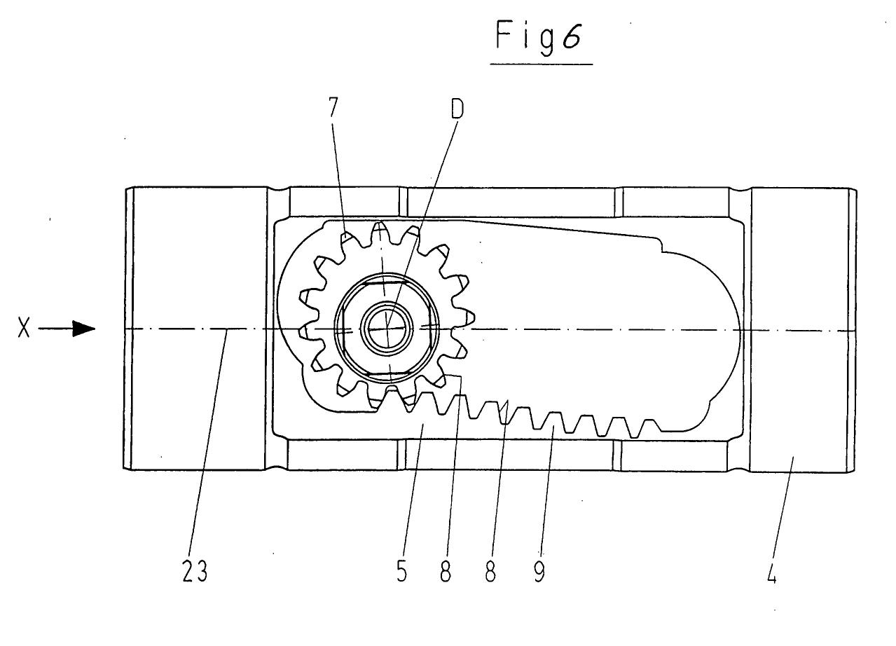

Respectively separated positions of pinion 6 are illustrated in the FIGS. 4 to 6. In this case, FIG. 4 illustrates the closing position, i.e. when the door is closed, namely the position of the piston 4 and of the pinion 6. In this case, the pinion 6 is located in the right zone of the aperture of piston 4. In this case, the rotary axis D is located on the center longitudinal axis 23. If the piston 4 is moved into the opening direction (direction of arrow X), the pinion 6 will rotate about the rotary axis D. Due to the eccentricity of pinion 6, a position arranged almost in a central region can be seen in FIG. 5, position that corresponds to a certain opening position of the door. Through the progression of pinion 6 at the toothed rack 5, the piston 4 has moved further into the opening direction.

As especially shown in FIG. 1 and in FIGS. 7 to 10, three control valves 11, 12, and 13, serving the delayed closing operation, are disposed in the housing walls 10 of the overhead door closer with slide arm assembly 1, and functions thereof will be explained hereinafter on the basis of FIGS. 7 to 10.

During the start of the closing procedure according to FIG. 7, the piston 4 passes an oil outlet duct 14, which, via a duct 19, is connected with a control valve 11 and via a duct 20 with a piston chamber 24. The oil exiting the piston chamber 24, via a longitudinal groove 16 in the skirt of the piston 15 and a radial borehole 17 in the piston 4, can pass over into the spring chamber 18. The ducts 25, 21, and 22, associated to the control valve 12, are arranged in another plane.

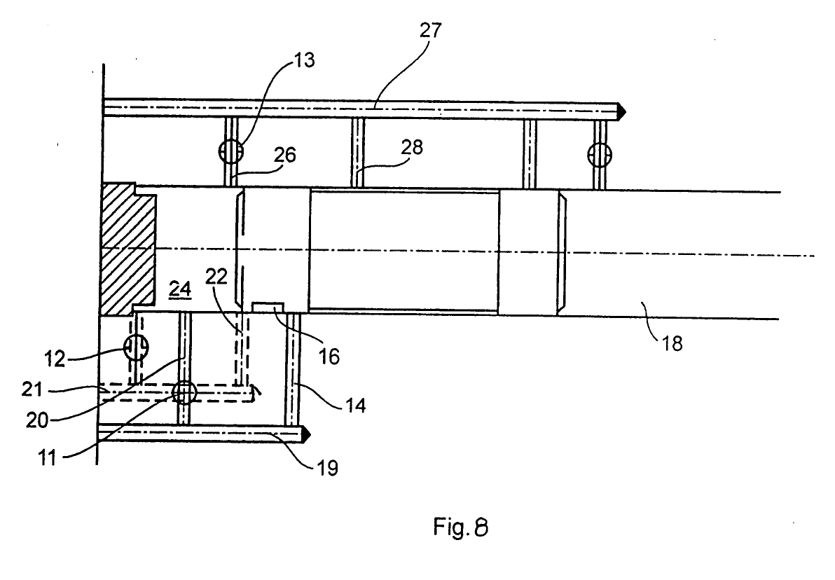

According to FIG. 8, the longitudinal groove 16 passed the duct 14, such that an oil transfer, from the piston chamber 24 to the spring chamber 18, is only possible due to the play between the piston 5 and the wall of the housing 10, resulting in a strong delay of the closing speed (second phase of the delayed closing operation).

During the third phase of the delayed closing operation, the oil passes again from the piston chamber 24, via the duct 20 and the same control valve 11 as well as the ducts 19 and 14 into the region of a not specifically illustrated overflow edge of piston 4, into the spring chamber 18. As the same control valve 11 is involved, the closing speed is identical in the first and in the third delaying phase.

During the fourth phase of the delayed closing operation (beginning of the closing region) the duct 20 of the valve 11 leading to the piston chamber 24 is closed; in this case the oil coming from the piston chamber 24 passes, via the duct 25, the control valve 12, the duct 21, and the duct 22 via the afore mentioned overflow edge, into the spring chamber 18. The control valve, referenced to with the numeral 13, is normally closed during the delayed closing operation; there is, however, the possibility of reducing the delaying period, through corresponding opening of this valve during the second closing phase (during which an oil exchange happens only through leakage between the piston and the housing walls), whereby the oil exiting the piston chamber 24 is conducted, while being reduced, via the duct 26, the control valve 13, the duct 27, and the duct 28, into the spring chamber 18.

An alternative embodiment with regard to the execution of the oil outlet ducts and the valves for controlling the closing procedure is illustrated in FIG. 11. In this alternative embodiment only two different closing phases are realised, such that a modification with regard to the above described four closing phases is possible. Therefore, only the valves 11 and 12 are required. The oil outlet duct 19 is extended and leads into an oil outlet duct 29 ending behind the not specifically designated overflow edge of piston 4 in the region of the toothed rack 5.

Besides the above described two embodiment examples with regard to different closing phases of the connected doors, it is of course possible, within the scope of the invention, to realise a different number of closing phases having various closing speeds.

REFERENCES

| | |
|---|---|
| 1 | overhead door closer with slide arm assembly |
| 2 | housing |
| 3 | closing spring |
| 4 | piston |
| 5 | toothed rack |
| 6 | pinion |
| 7 | involute toothing |
| 8 | closing-sided tooth profiles |
| 9 | teeth of the toothed rack |
| 10 | housing walls |
| 11 | control valve |
| 12 | control valve |
| 13 | control valve |
| 14 | oil outletduct |
| 15 | skirt of the piston |
| 16 | longitudinal groove |
| 17 | radial bore hole |
| 18 | spring chamber |
| 19 | oil outletduct |
| 20 | oil outlet duct |
| 21 | oil outlet duct |
| 22 | oil outlet duct |
| 23 | center longitudinal axis |
| 24 | piston chamber |
| 25 | oil outlet duct |
| 26 | oil outlet duct |
| 27 | oil outlet duct |
| 28 | oil outlet duct |
| 29 | oil outlet duct |
| M | central point of the pinion's rolling circle |
| D | rotary axis of the pinion |
| X | direction of the arrow in the opening direction |

1. An overhead door closer with slide arm assembly (1) having a piston (4) being guided in a housing (2) and leaning on a closing spring (3), having a toothed pinion (6) being eccentrically, rotatably supported at the housing (2) and meshing with a toothed rack (5) of the piston (4), which pinion presents a circular rolling curve, the central point (M) thereof being offset, in relation to the rotary axis (D) of the pinion (6) in the closing position, into the direction towards the toothed rack (5), and in relation to the rotary axis (D) in the opening position, into the opposite direction, characterized by the following characteristics:
a) the toothed rack (5) is executed as toothed rack profile, whereby its closing-sided tooth profiles (8) of the last teeth (9) in the opening direction (arrow X) are executed with an angle or convex curved;
b) the teeth (9) of the toothed rack (5) are arranged on a S-shaped rolling curve,
whereby,
respectively starting from the closing position:
the rolling curve is executed substantially in an ascending manner up to approximately half the length of the toothed rack (5) and subsequently in a descending manner;
all teeth (9) of the toothed rack (5) present different flank angles on the opening side and on the closing side;
the opening-sided flank angle of the teeth (9) substantially ascends up to approximately half the length of the toothed rack (5) and subsequently extends substantially in a constant manner;
the closing-sided flank angle of the teeth (9) substantially descends up to approximately half the length of the toothed rack (5) and subsequently extends in an ascending manner;
the width of the tooth head of the teeth (9) substantially ascends up to approximately half the length of the toothed rack (5) and subsequently extends in a descending manner;
c) the rotation of the pinion (6) from the closing position into the maximum opening position sums up to more than 180°, whereby the closing-sided tooth profiles (8) of the last teeth (9) of the toothed rack (5) in the opening direction (arrow X), which profiles are associated to the portion of the pinion (6) exceeding the 180°, are executed with an angle;
d) the piston (4) is guided within the housing (2) by means of at least one control valve (11, 12, 13) in a way delaying the closing operation.

2. An overhead door closer with slide arm assembly (1) having a piston (4) being guided in a housing (2) and leaning on a closing spring (3), having a toothed pinion (6) being eccentrically, rotatably supported at the housing (2) and meshing with a toothed rack (5) of the piston (4), which pinion presents a circular rolling curve, the central point (M) thereof being offset, in relation to the rotary axis (D) of the pinion (6) in the closing position, into the direction towards the toothed rack (5), and in relation to the rotary axis (D) in the opening position, into the opposite direction, characterized by the following characteristics:
a) the toothed rack (5) is executed as toothed rack profile, whereby its closing-sided tooth profiles (8) of the last teeth (9) in the opening direction (arrow X) are executed with an angle or convex curved;
b) the teeth (9) of the toothed rack (5) are arranged on a S-shaped rolling curve,
whereby,
respectively starting from the closing position:
the rolling curve is executed substantially in an ascending manner up to approximately half the length of the toothed rack (5) and subsequently in a descending manner;
all teeth (9) of the toothed rack (5) present different flank angles on the opening side and on the closing side;
the opening-sided flank angle of the teeth (9) substantially ascends up to approximately half the length of the toothed rack (5) and subsequently extends in a descending manner;
the closing-sided flank angle of the teeth (9) substantially descends up to approximately half the length of the toothed rack (5) and subsequently extends in an ascending manner; the width of the tooth head of the teeth (9) substantially ascends up to approximately half the length of the toothed rack (5) and subsequently extends in a descending manner;
c) the rotation of the pinion (6) from the closing position into the maximum opening position sums up to more than 180°, whereby the closing-sided tooth profiles (8) of the last teeth (9) of the toothed rack (5) in the opening direction (arrow X), which profiles are associated to the portion of the pinion (6) exceeding the 180°, are executed with an angle;
d) the piston (4) is guided within the housing (2) by means of at least one control valve (11, 12, 13) in a way to delay the closing operation.

3. An overhead door closer with slide arm assembly (1) having a piston (4) being guided in a housing (2) and leaning on a closing spring (3), having a toothed pinion (6) being eccentrically, rotatably supported at the housing (2) and meshing with a toothed rack (5) of the piston (4), which pinion presents a circular rolling curve, the central point (M) thereof being offset, in relation to the rotary axis (D) of the pinion (6) in the closing position, into the direction towards the toothed rack (5), and in relation to the rotary axis (D) in the opening position, into the opposite direction, characterized by the following characteristics:
a) the toothed rack (5) is executed as toothed rack profile, whereby its closing-sided tooth profiles (8) of the last teeth (9) in the opening direction (arrow X) are executed with an angle or convex curved;
b) the teeth (9) of the toothed rack (5) are arranged on a S-shaped rolling curve,
whereby
respectively starting from the closing position:
the rolling curve is executed substantially in an ascending manner up to approximately half the length of the toothed rack (5) and subsequently in a descending manner;
all teeth (9) of the toothed rack (5) present different flank angles on the opening side and on the closing side;
the opening-sided flank angle of the teeth (9) substantially ascends up to approximately half the length of the toothed rack (5) and subsequently extends substantially in a constant manner;
the closing-sided flank angle of the teeth (9) substantially descends up to approximately half the length of the toothed rack (5) and subsequently extends in an ascending manner;
c) the rotation of the pinion (6) from the closing position into the maximum opening position sums up to less than approximately 180°, whereby the closing-sided tooth profiles (8) of the last teeth (9) of the toothed rack (5) in the opening direction (arrow X), which profiles are associated to the portion of the pinion (6) approaching 180°, are executed with an angle;
d) the piston (4) is guided within the housing (2) by means of at least one control valve (11, 12, 13) in a way to delay the closing operation.

4. An overhead door closer with slide arm assembly according to one of the claims 1 to 3, characterized in that the pinion (6) and/or the toothed rack (5) present teeth having straight, angled or convex curved tooth profiles.

5. An overhead door closer with slide arm assembly according to one of the claims 1 to 4, characterized in that the pinion (6) presents an involute toothing (7).

6. An overhead door closer with slide arm assembly according to one of the claims 1 to 3, characterized in that the control valves (11, 12, 13) are located in a housing wall (10) of the housing (2), whereby two closing phases are associated to at least one of the control valves (11, 12, 13).

7. An overhead door closer with slide arm assembly according to one or several of the preceding claims, characterized in that the closing procedure comprises four phases of a delayed closing operation, whereby, while using two control valves (11, 12), the first control valve (11) controls, with the same closing speed, a first closing phase comprised between approximately 180° and 100°, as well as a third closing phase comprised between approximately 70° and 20°, whereas the second control valve (12) controls the fourth closing phase comprised between approximately 20° and 0° and the functioning of both control valves (11, 12) is cancelled in the second closing phase comprised between approximately 100° and 70°.

8. An overhead door closer with slide arm assembly according to one or several of the preceding claims, characterized in that an oil outlet duct (14) of the first control valve (11), in the first phase of the delayed closing operation, leads into a longitudinal groove (16) arranged in a skirt of the piston (15), which groove communicates with the spring chamber (18) via a spring-chamber-sided radial bore hole (17) of the piston (4) delimiting the longitudinal groove (16).

9. An overhead door closer with slide arm assembly according to one or several of the preceding claims, characterized in that the oil outlet duct (14) leads into an oil outlet duct (19), which, via the control valve (11), communicates with the oil outlet duct (20) that leads into a piston chamber (24).

10. An overhead door closer with slide arm assembly according to one or several of the preceding claims, characterized in that in the second phase of the delayed closing operation, due to a play between the piston (5) and the housing wall (10), a pressure compensation from the piston chamber (24) to the spring chamber (18) is possible.

11. An overhead door closer with slide arm assembly according to one or several of the preceding claims, characterized in that in the third closing phase, the oil from the piston chamber (24) passes, via the oil outlet duct (20), the control valve (11), and the oil outlet ducts (14, 19), and an overflow edge of the piston (5), into the spring chamber (18).

12. An overhead door closer with slide arm assembly according to one or several of the preceding claims, characterized in that, in a fourth phase of the closing procedure, the oil outlet duct (20) is closed, and the oil from the piston chamber (24) passes, via the oil outlet duct (25), through the control valve (12), and the oil outlet ducts (21) and (22), and via the overflow edge, into the spring chamber (18).
